(19) United States
(12) Patent Application Publication
(10) Pub. No.: US 2023/0399480 A1
(43) Pub. Date: Dec. 14, 2023

(54) FOAMS COMPRISING BLENDS OF SILICONE FUNCTIONALIZED POLYETHYLENE AND LOW DENSITY POLYETHYLENE

(71) Applicant: Dow Global Technologies LLC, Midland, MI (US)

(72) Inventors: Brian R. Dorvel, Missouri City, TX (US); Andrew T. Heitsch, Angleton, TX (US); Anson Sze Tat Wong, Midland, MI (US); Stéphane Costeux, Midland, MI (US); John O. Osby, Lake Jackson, TX (US); Jian Yang, Pearland, TX (US)

(73) Assignee: Dow Global Technologies LLC, Midland, MI (US)

(21) Appl. No.: 18/034,562

(22) PCT Filed: Oct. 29, 2021
(86) PCT No.: PCT/US2021/057321

§ 371 Date: Apr. 28, 2023

Related U.S. Application Data
(60) Provisional application No. 63/107,721, filed on Oct. 30, 2020.

(51) Int. Cl. C08J 9/00; C08J 9/12; C08L 23/06; C08G 77/42

(52) U.S. Cl. CPC C08J 9/0061; C08J 9/122; C08L 23/06; C08G 77/42; C08J 2323/06; C08J 2323/26; C08J 2383/10; C08L 2207/066; C08J 2203/06; C08G 2101/00

(57) ABSTRACT

According to various embodiments, a microcellular foam is provided, wherein the microcellular foam comprises a polymer blend, the polymer blend comprising: from 70 to 95% by weight low density polyethylene (LDPE); and from 5 to 30% by weight of polydimethylsiloxane grafted LDPE (PDMS-g-LDPE), wherein the microcellular foam has an average cell size of less than 60 μm.

### TECHNICAL FIELD

Embodiments of the present disclosure are generally related to polyethylene foams, and are more particularly related to foams manufactured using blends of silicone functionalized polyethylene and low density polyethylene.

### BACKGROUND

Conventional thermoplastic foams utilize low density polyethylene (LDPE) due to good processability as well as good mechanical properties. That said, there is a current need to produce lighter weight thermoplastic foams without sacrificing mechanical or electrical properties as well as increasing the throughput of the foaming processes.

### SUMMARY

The present disclosure meets this need by producing foams having polymer blends of polydimethylsiloxane grafted LDPE (PDMS-g-LDPE) and LDPE wherein the incorporation of PDMS provides an improved foam expansion ratio and smaller cell sizes within the foam. Improved expansion ratio can lead to lightweighting (i.e., less material needed to get same thickness) while smaller cell sizes at similar foam density can lead to improved mechanical properties, such as compressive strength and tensile strength.

According to one embodiment of the present disclosure, a microcellular foam is provided. The microcellular foam comprises a polymer blend, the polymer blend comprising from 70 to 95% by weight low density polyethylene (LDPE), and from 5 to 30% by weight of polydimethylsiloxane grafted LDPE (PDMS-g-LDPE), wherein the microcellular foam has a cell size of less than 60 μm.

According to another embodiment of the present disclosure, a method of producing microcellular foam is provided. The method comprises producing a polymer blend: by mixing from 70 to 95% by weight low density polyethylene (LDPE), and from 5 to 30% by weight of polydimethylsiloxane grafted LDPE (PDMS-g-LDPE); introducing the polymer blend to a batch foaming unit at a temperature of at least 75° C. and a pressure of at least 1000 psig in the presence of a physical blowing agent; and depressurizing the soaked polymer blend to produce the microcellular foam having an average cell size of less than 60 μm.

These and other embodiments are described in more detail in the following detailed description.

### BRIEF DESCRIPTION OF THE DRAWINGS

FIG. 1 graphically depicts the melt strength of samples according to embodiments disclosed and described herein and comparative samples; and

FIG. 2A-FIG. 2D are micrographs showing the cell size of samples according to embodiments disclosed and described herein and comparative samples.

### DETAILED DESCRIPTION

Specific embodiments of the present application will now be described. The disclosure may, however, be embodied in different forms and should not be construed as limited to the embodiments set forth in this disclosure. Rather, these embodiments are provided so that this disclosure will be thorough and complete, and will fully convey the scope of the subject matter to those skilled in the art.

### Definitions

Any reference to the Periodic Table of Elements is in reference to the International Union of Pure and Applied Chemistry (IUPAC) periodic table.

The numerical ranges disclosed herein include all values from, and including, the upper and lower values. For ranges containing explicit values (e.g., from 1 or 2 or 3 to 5 or 6 or 7), any subrange between any two explicit values is included (e.g., the range 1-7 above includes subranges of from 1 to 2; from 2 to 6, from 5 to 7; from 3 to 7; from 5 to 6; etc.).

Unless stated to the contrary, implicit from the context, or customary in the art, all parts and percentages are based on weight and all test methods are current as of the filing date of this disclosure.

The term “composition” refers to a mixture of materials, which comprise the composition, as well as reaction products and decomposition products formed from the materials of the composition.

The terms “comprising,” “including,” “having,” and their derivatives, are not intended to exclude the presence of any additional component, step, or procedure, whether or not the same is specifically disclosed. In contrast, the term “consisting essentially of” excludes from the scope of any succeeding recitation any other component, step, or procedure, excepting those that are not essential to operability. The term “consisting of” excludes any component, step, or procedure not specifically delineated or listed. The term “or,” unless stated otherwise, refers to the listed members individually as well as in any combination. Use of the singular includes the use of the plural and vice versa.

The term “polymer” refers to a polymeric compound prepared by polymerizing monomers, whether of the same or a different type, that in polymerized form provide the multiple and/or repeating “units” that make up a polymer. The generic term polymer thus embraces the term “homopolymer,” usually employed to refer to polymers prepared from only one type of monomer as well as “copolymer” which refers to polymers prepared from two or more different monomers. It is noted that although a polymer is often referred to as being “made of” one or more specified monomers, “based on” a specific monomer or monomer type, “containing” a specified monomer content, or the like, in this context, the term “monomer” is understood to be referring to the polymerized remnant of the specified monomer.

The terms “blend” or “polymer blend,” as used herein, refer to a mixture of two or more polymers. A blend may or may not be miscible (not phase separated at the molecular level). A blend may or may not be phase separated. A blend may be effected by physically mixing the two or more polymers on the macro level (for example, melt blending resins or compounding), or the micro level (for example, simultaneous forming within the same reactor).

“Polyethylene” or “ethylene polymer” or “ethylene-based polymer” shall mean polymers comprising greater than 50% by mole of units, which have been derived from ethylene monomer. This includes polyethylene homopolymers or copolymers (meaning units derived from two or more comonomers). Common forms of polyethylene known in the art include Low Density Polyethylene (LDPE); Linear Low Density Polyethylene (LLDPE); Ultra Low Density Polyethylene (ULDPE); Very Low Density Polyethylene (VLDPE); Medium Density Polyethylene (MDPE); and High Density Polyethylene (HDPE).

The term “LDPE” may also be referred to as “high pressure ethylene polymer” or “highly branched polyethylene” and is defined to mean that the polymer is partly or entirely homopolymerized or copolymerized in autoclave or tubular reactors at pressures above 14,500 psig (100 MPa) with the use of free-radical initiators, such as peroxides (see for example U.S. Pat. No. 4,599,392, which is hereby incorporated by reference). LDPE resins typically have a density in the range of 0.916 to 0.935 g/cc.

As used herein, the term “siloxane” includes polysiloxanes and lower molecular weight siloxanes. In embodiments, the siloxane is polydimethylsiloxane (PDMS) with various end groups described below.

The terms “foam” and “foam composition,” as used herein, refer to a structure constructed from a polymer and comprising a plurality of channels extending from the surface of the structure into, and through, the structure. The channels are free of direction with respect to the longitudinal extension of the structure. The channels comprise a plurality of foam cells that are in fluid communication with the external atmosphere. The term “foam cell,” or “cell,” as used herein, is a discrete space within the foam composition. The foam cell is separated, or otherwise defined, by membrane walls comprising the polymer of the foam composition.

The term “physical blowing agent,” as used herein, is a compound, or composition, that (i) is dissolved in the polymer composition under the extrusion conditions, by virtue of being sufficiently soluble in the polymer composition at those conditions and (ii) comes out of solution under conditions (temperature, pressure) encountered during formation of a foam composition, as the foamable composition exits the die. The physical blowing agent is added to the polymer blend under the extrusion conditions to form a foamable composition. The term “foamable composition,” as used herein, is a mixture of the polymer blend and the physical blowing agent under the extrusion conditions.

As used herein, the term “microcellular foam” means a foam having an average cell size less than 70 μm. The microcellular foam may encompass closed cell foams or open cell foams.

The term “foaming temperature” refers to the final set temperature in a cooling section of a foam extruder or other suitable heat exchanger, the cooling section or other suitable heat exchanger located directly upstream of the exit die. For example, the foaming temperature may be the set temperature of the last zone of an extruder used to cool the foamable composition. The set temperature may or may not be different from the extrudate (foamable composition) melt temperature that is measured at the exit die.

Embodiments of the present disclosure are directed to microcellular foams comprising a polymer blend, the polymer blend comprising from 70 to 95% by weight low density polyethylene (LDPE), and from 5 to 30% by weight of polydimethylsiloxane grafted LDPE (PDMS-g-LDPE), wherein the microcellular foam has an average cell size of less than 60 μm. It is contemplated in further embodiments that the microcellular foam may have an average cell size of less than 50 μm. Said another way, the microcellular foam has an average cell size of 40 μm to 60 μm. In a further embodiment, the microcellular foam comprises from 80 to 90 wt. % LDPE and 10 to 20 wt. % PDMS-g-LDPE.

In one or more embodiments, the polydimethylsiloxane grafted LDPE (PDMS-g-LDPE) is a structure wherein a portion of the ethylene-based polymer (e.g., LDPE) is bonded to one or more silicon atoms. In specific embodiments, at least one LDPE is bonded to the siloxane at a silicon atom. The PDMS-g-LDPE may be formed by high pressure, free-radical polymerization by reacting ethylene monomer and PDMS, or by reacting ethylene monomer and one or more polydimethylsiloxanes. In one embodiment, the polydimethylsiloxane grafted LDPE formed by free radical grafting of the LDPE onto a radicalized PDMS molecule.

In various embodiments described herein, the polydimethylsiloxane (PDMS) that includes one or more functional groups and is, therefore, referred to a functionalized PDMS, or f-PDMS. In various embodiments, the f-PDMS is a (meth)acrylate ester functionalized PDMS, where the (meth)acrylate ester group is bonded to the PDMS through a bridge group. The PDMS may be monofunctional or difunctional or polyfunctional, and the functional group(s) may be linked at a terminal or pendant location on the siloxane.

As would be familiar to the skilled person, the polydimethylsiloxane involves two methyl groups attached to each silicon atom. Suitable PDMS compounds and PDMS-g-LDPE compounds include those taught in U.S. Pat. No. 8,691,923, which is incorporated by reference herein in its entirety.

The PDMS of the PDMS-g-LDPE may alternatively be produced before or separately from the reaction process with the LDPE. Chain transfer agents or telogens (CTA) are typically used to control the melt index in a free-radical polymerization process. Chain transfer involves the termination of growing polymer chains, thus limiting the ultimate molecular weight of the polymer material. Chain transfer agents are typically hydrogen atom donors that will react with a growing polymer chain and stop the polymerization reaction of the chain. For high pressure free radical polymerization, these agents can be of many different types, such as saturated hydrocarbons, unsaturated hydrocarbons, aldehydes, ketones or alcohols. Typical CTA that can be used include, but are not limited to, propylene, isobutane, n-butane, 1-butene, methyl ethyl ketone, propionaldehyde, ISOPAR (ExxonMobil Chemical Co.), and isopropanol.

In one embodiment, free-radical initiator may be used in the process to initiate the graft site on the PDMS by extracting the extractable hydrogen from the PDMS. Example free-radical initiators include those free radical initiators previously discussed, such as peroxides and azo compounds. In one embodiment ionizing radiation may also be used to free the extractable hydrogen and create the radicalized site on the PDMS. Organic initiators are preferred means of extracting the extractable hydrogen, such as using dicumyl peroxide, di-tert-butyl peroxide, t-butyl perbenzoate, benzoyl peroxide, cumene hydroperoxide, t-butyl peroctoate, methyl ethyl ketone peroxide, 2,5-dimethyl-2,5-di(tert-butyl peroxy)hexane, lauryl peroxide, and tert-butyl peracetate, t-butyl-α-cumyl peroxide, di-t-butyl peroxide, di-t-amyl peroxide, t-amyl peroxybenzoate, 1,1-bis(t-butylperoxy)-3,3,5-trimethylcyclohexane, α,α′-bis(t-butylperoxy)-1,3-diisopropylbenzene, α,α′-bis(t-butylperoxy)-1,4-diisopropylbenzene, 2,5-bis(t-butylperoxy)-2,5-dimethylhexane, and 2,5-bis(t-butylperoxy)-2,5-dimethyl-3-hexyne. A preferred azo compound is azobisisobutyl nitrite.

In one embodiment, the PDMS-g-LDPE may be treated with one or more stabilizers, for example, antioxidants, such as IRGANOX 1010 and IRGAFOS 168 (Ciba Specialty Chemicals; Glattbrugg, Switzerland). In general, the polymers are treated with one or more stabilizers before extrusion or other melt processes. In one embodiment, polymeric additives include, but are not limited to, ultraviolet light absorbers, antistatic agents, pigments, dyes, nucleating agents, fillers, slip agents, fire retardants, plasticizers, processing aids, lubricants, stabilizers, smoke inhibitors, viscosity control agents and anti-blocking agents. The PDMS-g-LDPE composition may, for example, comprise less than 10 percent by the combined weight of one or more additives, based on the weight of the PDMS-g-LDPE.

The PDMS-g-LDPE may further be compounded. In one PDMS-g-LDPE composition, one or more antioxidants may further be compounded into the polymer and the compounded polymer pelletized. The compounded polymer may contain any amount of one or more antioxidants. For example, the compounded polymer may comprise from 200 to 600 parts of one or more phenolic antioxidants per one million parts of the polymer. In addition, the compounded polymer may comprise from 800 to 1200 parts of a phosphite-based antioxidant per one million parts of polymer. The compounded polymer may further comprise from 300 to 1250 parts of calcium stearate per one million parts of polymer.

Properties of the PDMS-g-LDPE and LDPE

In one embodiment, a PDMS-g-LDPE comprises at least 0.15, or at least 0.5, or at least 0.8, units of amyl groups per 1000 carbon atoms as determined by ¹³C Nuclear Magnetic Resonance (NMR). In one embodiment, the PDMS-g-LDPE comprises at least 1, or at least 1.2, or at least 1.4, units of C₆+ branches as determined by ¹³C NMR.

In one embodiment, the PDMS-g-LDPE comprises no appreciable methyl branches as determined by ¹³C NMR. In one embodiment, the PDMS-g-LDPE comprises no appreciable propyl branches as determined by ¹³C NMR. In one embodiment, the PDMS-g-LDPE comprises no greater than 5, or no greater than 3 or no greater than 2, units of amyl groups per 1000 carbon atoms as determined by ¹³C NMR.

In one embodiment, the PDMS-g-LDPE has a density of at least 0.925 g/cm³, or from 0.925 to 0.950 g/cm³. The LDPE may have a density from 0.916 to 0.935 g/cm³, or from to 0.925 g/cm³. The LDPE may have a melt index (I₂) from 0.15 to 10.0 g/10 mins, or from to 3.0 g/10 mins, or from 1.5 to 2.5 g/10 mins.

Moreover, the PDMS-g-LDPE has a melt index (I₂) of less than 10, or less than 5, or less than 3. Conversely, the PDMS-g-LDPE has a melt index (I₂) of greater than 0.5, or greater than 1.0.

In one embodiment, the PDMS-g-LDPE has a melt flow ratio (I₁₀/I₂) of least 13, or of at least 20, or of at least 40, or of at least 100, or of at least 200. Moreover, the PDMS-g-LDPE may have a melt index (I₂) from 0.5 to 15.0 g/10 mins. In another embodiment, the PDMS-g-LDPE has a melt flow ratio (I₁₀/I2) of least 100, or of at least 200. In one embodiment, the PDMS-g-LDPE has an I₂ of less than 5 and an I₁₀/I₂ of greater than 13. In another embodiment, the PDMS-g-LDPE of any of the preceding embodiments has an I₂ of less than 5 or less than 3 and an I₁₀/I₂ of greater than 30 or greater than 40. In yet another embodiment, the PDMS-g-LDPE of any of the preceding embodiments has an I₂ of less than 20 or less than 15 and an I₁₀/I₂ of greater than 12. In another embodiment, the PDMS-g-LDPE has a molecular weight distribution (MWD=Mw/Mn) of 5 to 50, or 7.0 to 50.0, or 7 to 25, or 7 to 10, or 5 to 10. The MWD is determined using Gel Permeation Chromatography as detailed below. Moreover, the PDMS-g-LDPE has a melt strength of at least 5 cN as measured by the methodology defined below.

In one embodiment, the PDMS-g-LDPE comprises 1 to 40 weight percent PDMS based on the weight of the PDMS-g-LDPE, or from 1 to 20 wt % PDMS based on the weight of the PDMS-g-LDPE, or from 1 to 15 wt % PDMS based on the weight of the PDMS-g-LDPE.

Process for Making Microcellular Foam

In accordance with one or more embodiments, microcellular foam may be produced by first generating a polymer blend by mixing from 70 to 95% by weight low density polyethylene (LDPE), and from 5 to 30% by weight of polydimethylsiloxane grafted LDPE (PDMS-g-LDPE). The blend may be produced via various processes familiar to the skilled person. For example, the components may be blended (e.g., melt blended) in an extruder or mixer. Then, the polymer blend is passed to a batch foamer at a temperature of at least 75° C. and a pressure of at least 1000 psig in the presence of a blowing agent, and then the polymer blend is rapidly depressurized to produce the microcellular foam having a cell size of less than 60 μm.

In one or more embodiments, the polymer blend is allowed to soak in the batch foamer for a period of at least 2 hours, or at least 4 hours. In alternative embodiments, the soaking may occur at temperatures of than 100° C. and greater, or 125° C. and greater. Moreover, the soaking step may occur at pressures of 1200 psig or greater. Many embodiments are contemplated as suitable for the batch foamer. These batch foamer units may include extruders as detailed below. Without being bound by theory, the temperature and pressure are sufficient to (i) prevent the blowing agent from creating expansion of the polymer composition and/or the foamable composition within the extruder or other suitable melt processing equipment and (ii) enable homogeneous dispersion of the blowing agent within the polymer composition.

In one or more embodiments, the depressurization may occur in less than 30 seconds, or less than 5 sec, or less than 1 second. In one embodiment, the depressurization may reduce the pressure to less than 1 psig.

As described above, in addition to the PDMS-g-LDPE, the composition from which the foam is formed includes a physical blowing agent. In one or more embodiments, the physical blowing agent comprises isobutane, nitrogen, carbon dioxide, n-butane, isomers of pentane, hydrocarbons, fluorocarbons, hydrofluorocarbons, or mixtures thereof, or mixtures thereof. The physical blowing agent, (e.g., isobutene or CO₂), may be present in an amount from 0.5 to 30 wt. %, or from 2 to 25 wt. %, or from 5 to 20 wt. %, or from 8 to 15 wt. %, based upon the total weight of the foamable composition, depending on the particular embodiment. In embodiments, the PDMS-g-LDPE exhibits an improved blowing efficiency such that the amount of physical blowing agent may be decreased as compared to a similar foamable composition without the PDMS-g-LDPE (e.g., a composition including LDPE and the blowing agent) in the foamable composition.

In other embodiments, one or more additional components may be added to the polymer composition, such as a permeability modifier, cell nucleating agent, an olefinic polymer, antistatic agents, pigments, fillers, or other additives known and used in the art.

Cell nucleating agents, when added to the extrudate, facilitate formation of one or more foam cells, and can lead to smaller cell sizes and a higher cell density. In one or more embodiments, the cell nucleating agent may be talc, calcium carbonate, or a chemical blowing agent. For example, the cell nucleating agent may be added to the extrudate as a talc coating on. When included, the cell nucleating agent may be present in an amount of from 0.01 to 10.0 wt. %, based on a total weight of the foamable composition. In one or more embodiments, the PDMS-g-LDPE can also act as a nucleating agent.

Moreover, one or more antistatic agents, pigments, fillers, or other additives may be included in the composition. Other additives can include, by way of example and not limitation, antioxidants, acid scavengers, ultraviolet light absorbers, flame retardants, processing aids, extrusion aids, or the like. When present, such additives may be present in an amount from greater than 0 to 20 wt. %, based on a total weight of the foamable composition.

Following addition of the physical blowing agent, the composition including the polymer blend and the physical blowing agent, (referred to herein as the “foamable composition”) is cooled to a foaming temperature. For example, the foamable composition can be cooled in a cooling extruder. In one or more embodiments, the foaming temperature is from about 50° C. to about 180° C. For example, the foaming temperature may be from 70° C. to 160° C., from 90° C. to 140° C., from 100° C. to 130° C., from 100° C. to 120° C., from 100° C. to 110° C., from 105° C. to 110° C., or from 105° C. to 118° C.

After cooling to the foaming temperature, in embodiments, the foamable composition is propelled from an exit die at the end of the cooling extruder and cured to form a foam composition. Foaming is accomplished when the foamable composition exits through a die of the extruder to a region of lower pressure, as compared to the pressure within the extruder, such that the foamable composition experiences a pressure drop as it exits the exit die of the extruder. The pressure drop causes the physical blowing agent to expand the foamable composition, thereby leading to foaming.

Uses

Embodiments of the foam described herein may be in any known physical form, including but not limited to, extruded sheets, rods, planks, films, and the like. Such foams may be used in, for example, cushion packaging, athletic and recreational products, egg cartons, meat trays, building and construction, acoustical insulation, pipe insulation, gaskets, vibration pads, luggage liners, desk pads, shoe holes, gymnastic mats, insulation blankets for greenhouses, case inserts, absorptive foams (e.g., to clean up oil spills, for health and hygiene applications, etc.) and display foams. Other applications, such as insulation for refrigeration, buoyancy applications, and floral and craft applications, are contemplated and possible.

### Testing Methods

The test methods include the following:

Melt Index (I₂) and (I₁₀)

Melt index (I₂) and melt index (I₁₀) are measured in accordance with ASTM D-1238 at 190° C. at 2.16 kg and 10 kg Method B, respectively. The values are reported in g/10 min (or dg/min), which corresponds to grams eluted per 10 minutes.

Density

Density of polymers are measured in accordance with ASTM D792-08, method B at 25° C. and reported in grams/cubic centimeter (g/cc or g/cm³).

Melt Strength

Melt strength measurements were conducted on a Gottfert Rheotens 71.97 (Göettfert Inc.; Rock Hill, S.C.), attached to a Gottfert Rheotester 2000 capillary rheometer. The melted sample (about 25 to 30 grams) was fed with a Göettfert Rheotester 2000 capillary rheometer, equipped with a flat entrance angle (180 degrees) of length of 30 mm, diameter of 2.0 mm, and an aspect ratio (length/diameter) of 15. After equilibrating the samples at 190° C. for 10 minutes, the piston was run at a constant piston speed of 0.265 mm/second. The standard test temperature was 190° C. The sample was drawn uniaxially to a set of accelerating nips, located 100 mm below the die, with an acceleration of 2.4 mm/s 2. The tensile force was recorded as a function of the take-up speed of the nip rolls. Melt strength was reported as the peak or maximum plateau force (cN) before the strand broke. The following conditions were used in the melt strength measurements: plunger speed=0.265 mm/second; wheel acceleration=2.4 mm/s²; capillary diameter=2.0 mm; capillary length=30 mm; and barrel diameter=12 mm.

Gel Permeation Chromatography (GPC)

The GPC system consists of a PolymerChar GPC-IR (Valencia, Spain) high temperature GPC chromatograph equipped with an internal IR5 infra-red detector (IR5) and 4-capillary solution viscometer (DV) coupled to a Precision Detectors (now Agilent Technologies, Amherst, MA) 2-angle light scattering (LS) detector Model 2040. A GPC with the last two independent detectors and at least one of the first detectors is sometimes referred to as “3D-GPC”, while the term “GPC” alone generally refers to “conventional GPC”. For all absolute light scattering measurements, the 15-degree angle was used for measurement. The autosampler oven compartment was operated at 160° C. and the column compartment was operated at 150° C. The columns used were 4 Agilent “Mixed A” 30 cm 20-micron linear mixed-bed columns. The chromatographic solvent used was 1,2,4 trichlorobenzene and contained 200 ppm of butylated hydroxytoluene (BHT). The solvent source was sparged with nitrogen. The polyethylene samples were gently stirred at 160° C. for four hours. The injection volume was 200 μL. The flow rate through the GPC was set at 1 mL/minute.

The GPC column set was calibrated before running the examples by running at least twenty narrow molecular weight distribution polystyrene standards. The molecular weight (MW) of the standards ranged from 580 to 8,400,000 grams per mole, and the standards were contained in 6 “cocktail” mixtures. Each standard mixture had at least a decade of separation between individual molecular weights. The standard mixtures were purchased from Agilent Technologies. The polystyrene standards were prepared at 0.025 g in 50 mL of solvent for molecular weights equal to or greater than 1,000,000 g/mol and 0.05 g in 50 mL of solvent for molecular weights less than 1,000,000 g/mol. The polystyrene standards were dissolved at 80° C. with gentle agitation for 30 minutes. The narrow standards mixtures were run first and in order of decreasing highest molecular weight component to minimize degradation. The polystyrene standard peak molecular weights were converted to polyethylene molecular weight using Equation 2 (as described in Williams and Ward, J. Polym. Sci., Polym. Let., 6, 621 (1968)):

M_{polystyrene}=A×(M_{polyethylene})^{B} (Eq. 2)

where M is the molecular weight of polyethylene or polystyrene (as marked), A has a value of 0.43, and B is equal to 1.0.

A polynomial between 3^{rd} and 5^{th} order was used to fit the respective polyethylene-equivalent calibration points. The total plate count of the GPC column set was performed with Eicosane (prepared at 0.04 g in 50 mL of TCB and dissolved for 20 minutes with gentle agitation). The plate count (Equation 3) and symmetry (Equation 4) were measured on a 200 μL injection according to the following equations:

$$Plate Count = 5.54 * {( \frac{{RV}_{Peak Max}}{Peak Width at \frac{1}{2} height} )}^{2} \qquad ( Eq . 3 )$$

where RV is the retention volume in mL, the peak width is in mL, the peak max is the maximum height of the peak, and ½ height is ½ height of the peak maximum.

$$Symmetry = \frac{( Rear Peak {RV}_{one tenth height} - {RV}_{Peak max} )}{( {RV}_{Peak max} - Front Peak {RV}_{one tenth height} )} \qquad ( Eq . 4 )$$

where RV is the retention volume in mL and the peak width is in mL, Peak max is the maximum position of the peak, one tenth height is 1/10 height of the peak maximum, and where rear peak refers to the peak tail at later retention volumes than the peak max and where front peak refers to the peak front at earlier retention volumes than the peak max. The plate count for the chromatographic system should be greater than 24,000 and symmetry should be between 0.98 and 1.22.

Samples were prepared in a semi-automatic manner with the PolymerChar “Instrument Control” Software, wherein the samples were weight-targeted at 2 mg/mL and the solvent (contained 200 ppm BHT) was added to a pre-nitrogen-sparged septa-capped vial, via the PolymerChar high temperature autosampler. The samples were dissolved for 2 hours at 160° C. under “low speed” shaking.

The calculations of Mn_{(GPC)}, Mw_{(GPC)}, and Mz_{(GPC)} were based on the GPC results using the internal IRS detector (measurement channel of the PolymerChar GPC-IR chromatograph according to Equations 5-7, using PolymerChar GPCOne™ software, the baseline-subtracted IR chromatogram at each equally-spaced data collection point (i), and the polyethylene equivalent molecular weight obtained from the narrow standard calibration curve for the point (i) from Equation 2.

$${Mn}_{( GPC )} = \frac{{\sum }^{i} {IR}_{i}}{{\sum }^{i} ( {IR}_{i} / {M}_{{polyethylene}_{i}} )} \qquad ( Eq . 5 )$$

$${Mw}_{( GPC )} = \frac{{\sum }^{i} ( {IR}_{i} * {M}_{{polyethylene}_{i}} )}{{\sum }^{i} {IR}_{i}} \qquad ( Eq . 6 )$$

$${Mz}_{( GPC )} = \frac{{\sum }^{i} ( {IR}_{i} * {{M}_{{polyethylene}_{i}}}^{2} )}{{\sum }^{i} ( {IR}_{i} * {M}_{{polyethylene}_{i}} )} \qquad ( Eq . 7 )$$

In order to monitor the deviations over time, a flow rate marker (decane) was introduced into each sample via a micropump controlled with the PolymerChar GPC-IR system. This flow rate marker (FM) was used to linearly correct the pump flow rate (Flowrate(nominal)) for each sample by RV alignment of the respective decane peak within the sample (RV(FM Sample)) to that of the decane peak within the narrow standards calibration (RV(FM Calibrated)). Any changes in the time of the decane marker peak are then assumed to be related to a linear-shift in flow rate (Flowrate(effective)) for the entire run. To facilitate the highest accuracy of a RV measurement of the flow maker peak, a least-squares fitting routine is used to fit the peak of the flow marker concentration chromatogram to a quadratic equation. The first derivative of the quadratic equation is then used to solve for the true peak position. After calibrating the system based on a flow marker peak, the effective flow rate (with respect to the narrow standards calibration) is calculated as Equation 8. Processing of the flow marker peak was done via the PolymerChar GPCOne™ Software. Acceptable flow rate correction is such that the effective flow rate should be within +/−2% of the nominal flow rate.

$${Flowrate}_{( effective )} = {Flowrate}_{( nominal )} * ( \frac{{RV}_{( FM Calibrated )}}{{RV}_{( FM Sample )}} ) \qquad ( Eq . 8 )$$

PDI is computed as Mw divided by Mn (i.e. Mw/Mn).

Triple Detector GPC (3D-GPC)

The chromatographic system, run conditions, column set, column calibration, and calculation conventional molecular weight moments and the distribution were performed according to the method described in the Gel Permeation Chromatography (GPC).

For the determination of the viscometer and light scattering detector offsets from the IR5 detector, the systematic approach for the determination of multiple detector offsets was performed in a manner consistent with that published by Balke, Mourey, et al. (Mourey and Balke, Chromatography Polym., Chapter 12, (1992)) (Balke, Thitiratsakul, Lew, Cheung, Mourey, Chromatography Polym., Chapter 13, (1992)), optimizing triple detector log (M_{w} and intrinsic viscosity) results from a broad homopolymer polyethylene standard (Mw/Mn>3) to the narrow standard column calibration results from the narrow standards calibration curve using PolymerChar GPCOne™ Software.

The absolute molecular weight data was obtained in a manner consistent with that published by Zimm (Zimm, B. H., J. Chem. Phys., 16, 1099 (1948)) and Kratochvil (Kratochvil, P., Classical Light Scattering from Polymer Solutions, Elsevier, Oxford, NY (1987)). The overall injected concentration used in the determination of the molecular weight is obtained from the mass detector area and the mass detector constant derived from a suitable linear polyethylene homopolymer, or one of the polyethylene standards of known weight-average molecular weight. The calculated molecular weights (using GPCOne™) are obtained using a light scattering constant derived from one or more of the polyethylene standards mentioned and a refractive index concentration coefficient, dn/dc, of 0.104. Generally, the mass detector response (IRS) and the light scattering constant (determined using GPCOne™) should be determined from a linear standard with a molecular weight in excess of about 50,000 g/mol. The viscometer calibration (determined using GPCOne™) can be accomplished using the methods described by the manufacturer or alternatively by using the published values of suitable linear standards such as Standard Reference Materials (SRM) 1475a (available from National Institute of Standards and Technology (NIST)). A viscometer constant (obtained using GPCOne™) is calculated which relates specific viscosity area (DV) and injected mass for the calibration standard to its intrinsic viscosity. The chromatographic concentrations are assumed low enough to eliminate addressing 2^{nd} viral coefficient effects (concentration effects on molecular weight).

The absolute weight average molecular weight (Mw_{(Abs)} is obtained (using GPCOne™) from the Area of the Light Scattering (LS) integrated chromatogram (factored by the light scattering constant) divided by the mass recovered from the mass constant and the mass detector (IR5) area. The molecular weight and intrinsic viscosity responses are linearly extrapolated at chromatographic ends where signal to noise becomes low (using GPCOne™). Other respective moments, Mn_{(Abs)} and Mz_{(Abs)} are calculated according to equations 9-10 as follows:

$${Mn}_{( Abs )} = \frac{{\sum }^{i} {IR}_{i}}{{\sum }^{i} ( {IR}_{i} / {M}_{{Absolute}_{i}} )} \qquad ( Eq . 9 )$$

$${Mz}_{( Abs )} = \frac{{\sum }^{i} ( {IR}_{i} * {{M}_{{Absolute}_{i}}}^{2} )}{{\sum }^{i} ( {IR}_{i} * {M}_{{Absolute}_{i}} )} \qquad ( Eq . 10 )$$

PDI is computed as Mw divided by Mn (i.e. Mw/Mn).

### EXAMPLES

The following examples illustrate features of the present disclosure but are not intended to limit the scope of the disclosure.

In the following examples, foams were produced from PDMS-g-LDPE, AGILITY™ 1021 LDPE, and blends of both.

AGILITY™ 1021, which is produced by Dow Inc, Midland, MI, is an LDPE having a density of 0.919 g/cc and an I₂ of 1.9 g/10 mins.

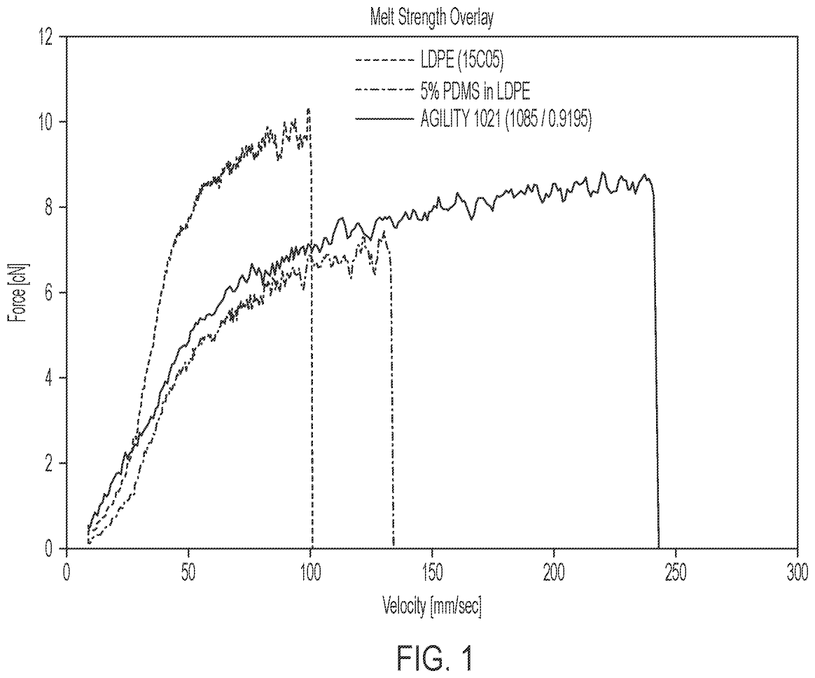

The PDMS-g-LDPE was produced in a continuously stirred tank reactor (CSTR) with a volume of 54 ml at 1925 bar (27,920 psig). The reaction temperature was 240° C. The CSTR was equipped with an external heating jacket. The agitator speed was 1600 revolutions per minute (rpm). The ethylene flow rate was 5450 gram/hr. Polydimethylsiloxane (PDMS) (Dow Corning PMX-200 Fluid 12,500 CST) was dissolved in ethyl acetate at a 40% by weight basis. The PDMS-solution was injected into the CSTR at a flow rate of 93.1 ml/hr (34.4 gram/hr of pure PDMS) such that ethylene polymerization occurred in the presence of the PDMS. Propylene was used as the chain transfer agent (CTA). The initiator was made up of 96.4 g tert-butyl peroxyacetate dissolved in 2172 mL Isopar E and injected into the CSTR at a flow rate of 36.2 mL/hr. The PDMS-g-LPDE, which included 5% by weight of PDMS, was collected in a vented polyethylene bottle, and excess gases were vented off. Subsequent steps were used to pelletize the PDMS-g-LDPE prior to blending. The results of the PDMS-g-LPDE are reported in Table 1. FIG. 1 graphically depicts the melt strength of various samples.

TABLE 1
Results of PDMS-g-LPDE

| | |
|---|---|
| I2 (g/10 min) | 2.1 |
| I10 (g/10 min) | 25.8 |
| I10/I2 | 12.4 |
| Density (g/cm3) | 0.922 |
| Mn_{conv.} (g/mol) | 21,389 |
| Mw_{conv.} (g/mol) | 152,134 |
| Mz_{conv.} (g/mol) | 769,294 |
| MWD (Mw_{conv.}/Mn_{conv.}) | 7.11 |
| Melt Strength (cN) | 7.0 |

The blends were produced in a Haake blender at a temperature of 180° C., a rotor speed of 60 rpm, and a mixing time of 10 minutes. After mixing, the blends were compression molded into plaques having a length of ¼ inches (0.64 cm), a width of ¼ inches (0.64 cm), and thickness of 1/16 inches (0.16 cm). The plaque samples were delivered to a 1000 mL batch foamer, which utilized CO₂ as the blowing agent. The samples were kept in the batch foamer at a temperature of 100° C. and pressure of 1200 psig for 4 hours of soak time. Then, the samples were depressurized to approximately 0 psig in less than a second. This fast depressurization played a role producing the cell size of the foams listed in Table 2. After depressurization, a cross-section of the foam was sliced and evaluated for cell size by Scanning Electron Microscopy (SEM).

TABLE 2
Sample Foams

| Foam | Wt. % | Wt. % | Average Cell | Qualitative |
|---|---|---|---|---|
| Sample | LDPE | PDMS-g-LDPE | Size (μm) | Foam Analysis |
| Inventive | 80% | 20% | 44 | |
| Example 1 | | | | |
| Comparative | 0% | 100% | 39 | Large gas |
| Example A | | | | pocket formed |
| Inventive | 90% | 10% | 58 | |
| Example 2 | | | | |
| Comparative | 100% | 0% | 92 | |
| Example B | | | | |

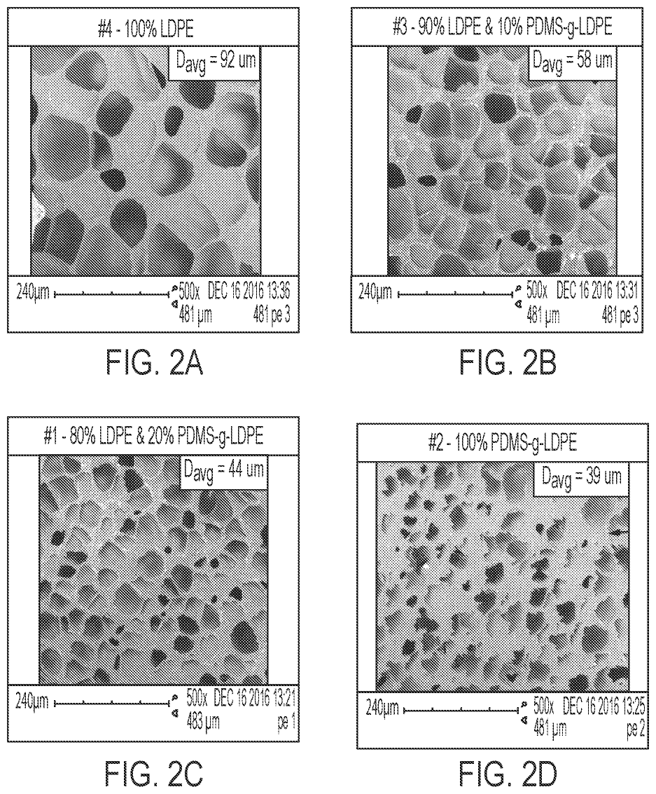

As shown, Inventive Examples 1 and 2, which are the blends of LDPE and PDMS-g-LDPE, achieved a foam average cell size of less than 60 μm. In contrast, the all LDPE Comparative Example B achieved a much larger foam average cell size of 92 μm, which is much larger than the foam cell sizes of Inventive Examples 1 and 3. Moreover, the all PDMS-g-LDPE Comparative Example A achieved an average cell size below 60 μm; however, a large gas pocket formed in the foam, which is problematic for the mechanical strength properties of the foam. Only the Inventive Examples achieved the balance of smaller average cell size and suitable strength. The cell sizes are shown in the micrograph images of FIG. 2A-FIG. 2D.

It will be apparent that modifications and variations are possible without departing from the scope of the disclosure defined in the appended claims. More specifically, although some aspects of the present disclosure are identified herein as preferred or particularly advantageous, it is contemplated that the present disclosure is not necessarily limited to these aspects.

1. A microcellular foam comprising a polymer blend, the polymer blend comprising:
from 70 to 95% by weight low density polyethylene (LDPE); and
from 5 to 30% by weight of polydimethylsiloxane grafted LDPE (PDMS-g-LDPE),
wherein the microcellular foam has a cell size of less than 60 μm.

2. The microcellular foam of claim 1, wherein the microcellular foam comprises from 80 to 90 wt. % LDPE and 10 to 20 wt. % PDMS-g-LDPE.

3. The microcellular foam of claim 1, wherein the LDPE has a density from 0.916 to 0.935 g/cc and a melt index (I₂) from 0.5 to 10.0 g/10 mins.

4. The microcellular foam of claim 1, wherein the PDMS-g-LDPE has a density from 0.915 to 0.955 g/cc and a melt index (I₂) from 0.5 to 15.0 g/10 mins.

5. The microcellular foam of claim 1, wherein the PDMS-g-LDPE comprises from 1 to 40 wt % PDMS, based on weight of the PDMS-g-LDPE.

6. A method of producing microcellular foam comprising
producing a polymer blend by mixing from 70 to 95% by weight low density polyethylene (LDPE), and from 5 to 30% by weight of polydimethylsiloxane grafted LDPE (PDMS-g-LDPE)
introducing the polymer blend to a batch foamer at a temperature of at least 75° C. and a pressure of at least 1000 psig in the presence of a physical blowing agent; and
depressurizing the soaked polymer blend to produce the microcellular foam having a cell size of less than 60 μm in less than 5 seconds.

7. The method of claim 6, wherein the depressurization occurs in less than 1 second.

8. The method of claim 6, wherein the depressurization reduces the pressure to less than 5 psig.

9. The method of claim 6, wherein the physical blowing agent comprises isobutane, nitrogen, carbon dioxide, n-butane, isomers of pentane, hydrocarbons, fluorocarbons, hydrofluorocarbons, or mixtures thereof.

10. The method of claim 6, wherein the polymer blend is maintained with the batch foamer for a period of at least 0.5 hours.

11. The method of claim 6, wherein the microcellular foam comprises from 80 to 90 wt. % LDPE and 5 to 20 wt. % PDMS-g-LDPE.

12. The method of claim 6, wherein the LDPE has a density from 0.916 to 0.935 g/cc and a melt index (I₂) from 0.5 to 10.0 g/10 mins.

13. The method of claim 6, wherein the PDMS-g-LDPE has a density from 0.915 to 0.955 g/cc and a melt index (I₂) from 0.5 to 15.0 g/10 mins.

14. The method of claim 6, wherein the PDMS-g-LDPE comprises from 1 to 40 wt % PDMS, based on weight of the PDMS-g-LDPE.
